(19) United States
(12) Patent Application Publication
(10) Pub. No.: US 2011/0187927 A1
(43) Pub. Date: Aug. 4, 2011

(54) DEVICE AND METHOD FOR SYNCHRONISATION OF DIGITAL VIDEO AND AUDIO STREAMS TO MEDIA PRESENTATION DEVICES

(76) Inventor: Colin Simon, New South Wales (AU)

(21) Appl. No.: 12/808,789

(22) PCT Filed: Dec. 19, 2008
(86) PCT No.: PCT/AU2008/001877

§ 371 Date: Sep. 14, 2010

(30) Foreign Application Priority Data
Dec. 19, 2007 (AU) 2007906931

(51) Int. Cl. H04N 5/04

(52) U.S. Cl. 348/500; 348/E05.009

(57) ABSTRACT

The invention has been developed for use as a device and a method to effectively synchronise post-processed graphics and audio streams for media presentation devices and attached devices such an attached sound systems. This invention is for digital television, including convergent television apparatus and systems delivered from a various sources such as over the internet.

The present invention relates to data processing and in particular to data processing of digital video and audio streams for audio visual output.

The invention has been developed for use as a device and a method to effectively synchronise post-processed graphics and audio streams for media presentation devices and attached devices such an attached sound systems. This invention is for digital television, including convergent television apparatus and systems delivered from a various sources such as over the internet. However, it will be appreciated that the invention is not restricted this particular field of use.

### PROBLEMS OF THE PRIOR ART

The technology required to deliver and receive digital television (including convergent television) is known to suffer a number of defects. For example, limitations of bandwidth and compression technology are known to reduce picture quality. Another problem with digital television is that a noticeable lag between the delivery of the visual output and the audio output arises when the processing of the visual data stream (resource intensive) is not fast enough to keep pace with processing of the audio data stream.

This problem with lag between picture and sound (the Lip Synchronisation Problem) affects all forms of digital television, including digital terrestrial television (requiring viewers to have an antenna), digital cable, digital satellite, digital microwave and convergent television (internet protocol television), because viewers need to have a device that decodes the digital signals into signals that the television can display (so the television screen, display or panel acts as a monitor). As increasing numbers of viewers switch to digital television, whether by choice or because of an imminent “switch-off” of analogue broadcast services, the Lip Synchronisation Problem will affect larger numbers of consumers and the need to address it will be more pressing.

The changing nature of the media landscape, including the reality of convergent television (internet protocol (IP) television) for delivering television content, video on demand (VoD), voice over IP telephony (VoIP), and enabling access to the Web and to other applications (such as web and video conferencing and other business to business applications, remote health, pod- and vodcasting) onto a media presentation device, will also serve to bring the problem of lag to the fore. To date, the technology used for accessing media presentation devices, particularly for convergent television delivered over the internet, has had limited success due to this Lip Synchronisation Problem.

The Lip Synchronisation Problem can occur at a number of stages during audio visual streaming and casting (narrowcasting or broadcasting). As a rule, the graphics stream (for video or visual output) demands greater processing (including decoding) at the receiving device than the accompanying audio stream(s) (for sound). These processing demands change as the picture and audio processing demands change. This results in each stream having a significantly different processing time and hence a delay between reception of the sound and the accompanying picture. This delay can be pronounced; significantly reducing the viewer's viewing experience.

Attempts to overcome this problem by including video and audio in a single data stream, can still result in a time lag between the audio and video components during processing of the data stream. In such cases, it has being known that it is necessary to delay the audio signal from the graphics signal electronically to allow for the time difference. However, this solution is not currently incorporated in media presentation devices (such as liquid crystal display LCD or plasma display panels or screens) that are used to display digital data streams (containing video and audio components) that may come from a range of different sources resulting in different and variable delays. For example, VoIP, internet gaming and DVB all require different adjustments which can also vary depending on the resolution of the video display and the quality of the audio output. Therefore, introducing a set delay to the audio signal is not an effective universal solution to the problem of Lip Synchronisation.

Additional problems with digital streams being delivered to media presentation device(s) include:
(a) delivery of the digital stream over the plain old telephone system (POTS)—that is, via twisted copper pair. The resultant poor bandwidth results in the need for considerable compression and coding (often MPEG-2 or MPEG-4) of the data stream (using internet protocol and accompanying streaming protocols) carrying the video, audio and other data in a multiplexed form; and
(b) on arrival at the receiving apparatus, the digital stream must be decompressed, decoded and de-multiplexed for processing into audio, video and other data streams for display on the media presentation device (such as a digital display panel).

Each of the above steps takes considerable processing resources, which creates de-synchronisation (including lag) of each of the audio, video and data streams (channels).

Known means for using time compression and expansion techniques to align video and audio streams involves a processor that uses a gate function to detect and modify word separation. Techniques includes fast Fourier transform algorithms to change the time basis without affecting the audio quality; however, fast Fourier transform algorithms are processor resource intensive, resulting in other problems such as poor video image.

There are a number of other devices that electronically attempt to buffer the audio output such that it synchronises to the graphics output. However, these devices are problematic for resource intensive graphic and audio outputs. An example of such a system is that offered by VizionWare referred to as the VZ-S5100¹ digital audio synchroniser, which provides a programmable lip-sync audio delay system which can range from 0 milliseconds to 100 milliseconds in 2-millisecond increments. This system requires manipulation of the audio signal as well as programming skills to use such a device. ¹ Dixon, L and Melin, E (2007) What's New: AUDIO TECHNOLOGY Sound & Video Contractor p79 Volume 25; Number 11

Further devices incorporate software solutions that place additional demands on the stretched processor(s) resources. For example see the releases by Tektronix at http://www.tek.com/Measurement/App_Notes/20_{—}14229/eng/20W_{—}14229_{—}0.pdf Commonly, when processor resources are stretched, it is only possible to use such solutions on low screen resolutions and audio environments. These solutions do not address the problem with processor data bottlenecks in high quality digital broadcasts.

Other devices provide buffered preprocessing of the signal and therefore there is no fine control of the synching requirements. Such buffering can also bring in accompanying problems such as poor picture resolution and sound quality, along with jagged picture delay. This audio-video synching problem is a major problem with digital services as highlighted recent publications.² ² See Bachofen, R and Chernock, R (2007) ATSC bit stream verification Broadcast Engineering p66 Volume 49; Number 11. 1 Nov. 2007

Consequently, the user experience of using devices to deliver digital content to media presentation devices has so far been unsatisfactory. One primary reason is that lip-synching of the sound to the picture often falls outside of the viewer's tolerance. A research paper by Stanford University 1993³ found that the Lip Synchronization Problem results in “viewer stress which in turn leads to viewer dislike of the television program they are watching”. ³ Reeves, B and Voelker, D (1993) Effects of Audio-Video Asynchrony on Viewer's Memory, Evaluation of Content and Detection Ability http://www.lipfix.com/file/doc/reeves_and_voelker_paper.pdf

The invention herein described seeks to overcome at least some of the problems of the prior art.

Before turning to other parts of this description, it must be appreciated that the above description of the prior art has been provided merely as background to explain the context of the invention. Accordingly, reference to any prior art in this specification is not, and should not be taken as an acknowledgement of or any form of suggestion that this prior art forms part of the common general knowledge in any country.

### OBJECT OF THE INVENTION

It is an object of the present invention to overcome or ameliorate at least one of the disadvantages of the prior art, or to provide a useful alternative.

According to one aspect of the invention there is provided a synchronisation device for synchronisation of data streams, wherein said synchronisation device includes a dedicated synchronisation means and wherein said dedicated synchronisation means:
(a) includes one or more of the following:
   i. one or more processors;
   ii. fixed-function hardware; and
(b) is dedicated to synchronisation of post-processed data streams, such that said synchronisation device is enabled to output synchronised data to one or more of the following:
   A. one or more Media Presentation Devices;
   B. one or more sound devices.

According to another aspect of the invention, there is provided a method for synchronisation of data streams, wherein said method includes the step of performing synchronisation of post-processed data streams, wherein said synchronisation is performed by a dedicated synchronisation means and wherein said synchronisation means includes one or more of the following:
(a) one or more processors;
(b) fixed-function hardware,
   such that said synchronisation means is enabled to output synchronised data to one or more of the following:
i. one or more Media Presentation Devices;
ii. one or more sound devices

A preferred embodiment of the invention will now be described, by way of example only, with reference to the accompanying drawings in which:

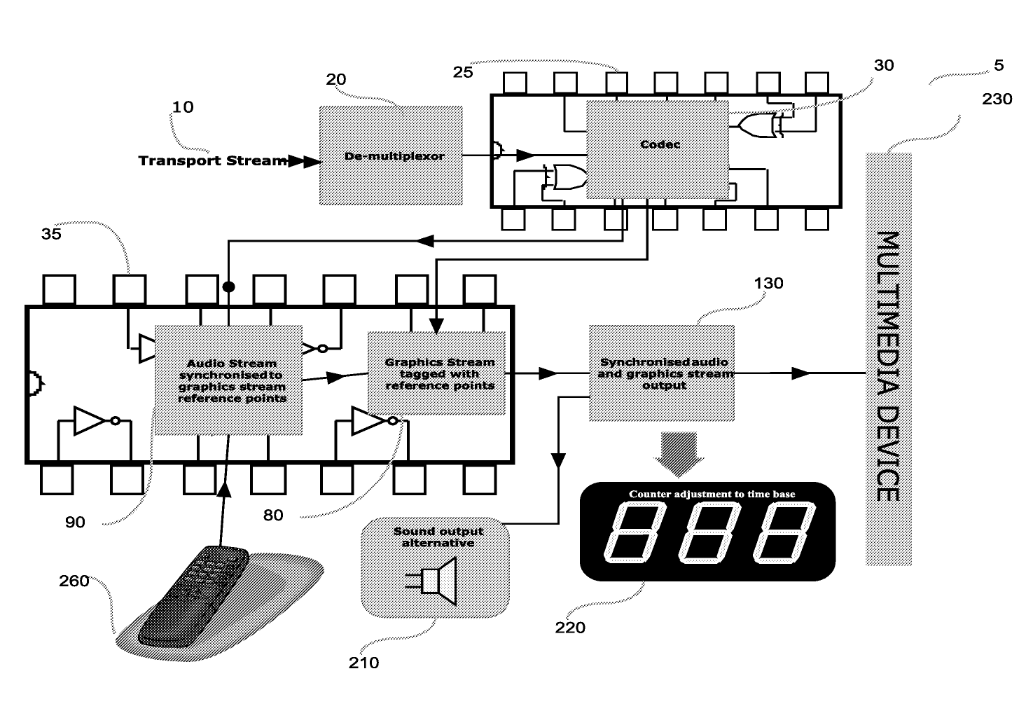

FIG. 1 illustrates, in block diagram form, a system for processing a transport stream data into an audio signal synchronized to a graphics stream in accordance with an embodiment of the present invention.

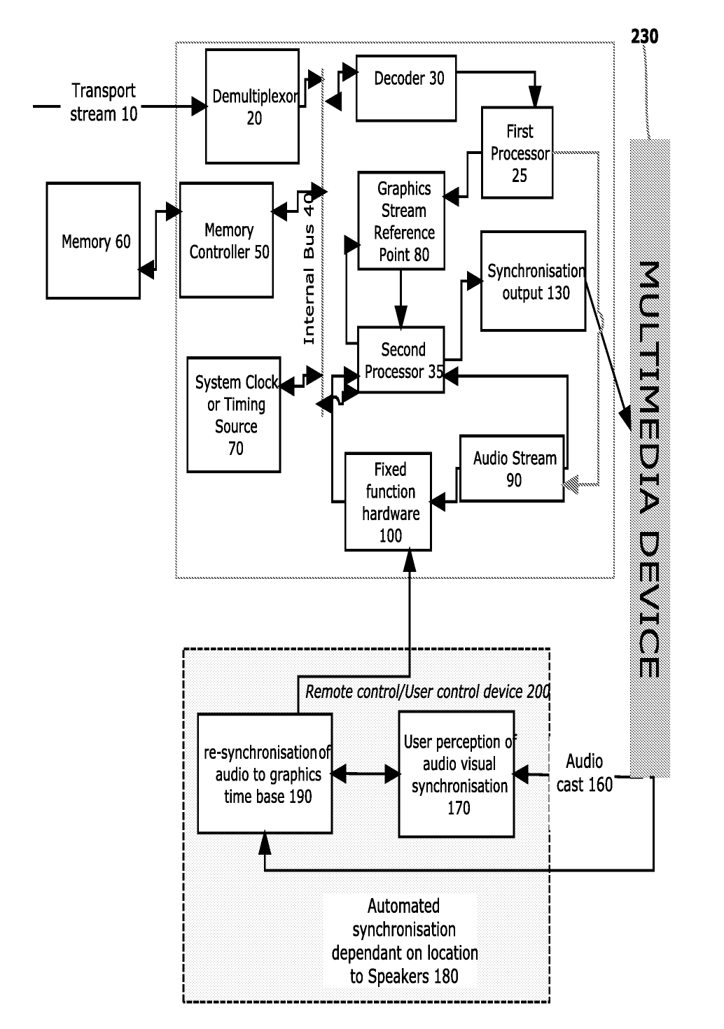

FIG. 2 illustrates, in block diagram form, a lip synching apparatus in accordance with an embodiment of the present invention.

### DETAILED DESCRIPTION

A preferred embodiment of the present invention will now be described by reference to the drawings. The following detailed description in conjunction with the figures provides the skilled addressee with an understanding of the invention. It will be appreciated, however, that the invention is not limited to the applications described below.

### Dictionary of Defined Terms

Table 1 is a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description |
|---|---|
| 8950 | The PNX8950 NXP processing chip, which includes one MIPS |
| | processor and two 32-bit 270 MHz “VLIW” media processors |
| | called TriMedia processors. It will be appreciated by those |
| | skilled within the art that this multi-core processor is used for |
| | example and other multi-core are envisaged to also be able to |
| | be used (see http://gotw.ca/publications/concurrency-ddj.htm |
| | and |
| | http://www.nytimes.com/2007/12/17/technology/17chip.html?adxnnl= |
| | 1&adxnnlx=1197954290-Mh29VWWf0QcuT7F30rEgTA |
| Lip Synching or Lip | Synchronisation of video, audio and other data streams |
| Synchronisation | according to the invention |
| Lip | Delay between video (graphic stream, picture) display and |
| Synchronisation | accompanying audio (sound) data—not confined to |
| Problem | synchronisation of lip movement seen on the display and sound |
| | but termed “lip synching” because this is often the most |
| | obvious and disruptive problem noted by viewers. Any |
| | multichannel syncing is envisaged to be included in this |
| | synchronisation problem, which is capture by the term “lip |
| | sync”. |
| Media | Digital display panel for viewing media, including liquid crystal |
| Presentation | display (LCD) panel, plasma panel, computer screen or |
| Device | television screen. This media presentation device is particularly |
| | suitable for convergent television where multiple streams of |
| | data are utilised from many different sources including IPTV, |
| | video conferencing, data streaming etcetera. |

The present invention provides a device, method and system for integrating the delivery of audio, video and other digital data from a plurality of sources to a media presentation device that presents information to the user. These devices may include televisions (including convergent television/IPTV), personal computers, video phones, online games, digital panels and other applications and devices requiring audio and video display.

The elements of the invention are now described under the following headings:

### An Improved Synchronisation System, Method and Apparatus

The present invention is a system, method and apparatus for improved synchronisation of multiple data streams (or channels) to a media presentation device (such as a digital display panel used for viewing digital television) and/or an audio device.

The invention includes:
(a) synchronisation means for post-processing synchronisation of data streams “on the wire”. In a preferred embodiment, the synchronisation means involves:
   i. fixed-function hardware;
   ii. software on a post-processing or second processor; or
   iii. a combination of the above for buffering and acceleration without the problems of data underflow or overflow; and
(b) adjustment means to enable control, adjustment or fine-tuning of synchronisation of data streams (channels) for output to a media presentation device. The adjustment means may be automated and/or user-controlled (e.g. using a control device such as a remote control or other wireless communication means, including a mobile phone, gaming controller or near-field communication technology)

FIG. 1 illustrates, in block diagram form, a method and system for post-processing a transport stream into an audio stream synchronised with a graphics stream and possibly other data streams in accordance with a preferred embodiment 5 of the present invention, including:
(a) input data is received by the preferred embodiment 5 from one or more data sources; the input data is received as one or more transport streams 10, e.g. digital television broadcast, internet podcast or vodcast, video conferencing, or radio streaming;
(b) each transport stream 10 passes through a de-multiplexor 20 and is de-multiplexed into multiple post-processed data streams—such as audio, video and other data such as MPEG-2, which has both audio and visual data;
(c) the preferred embodiment includes one or more first processors 25 (e.g. a VLIW processor such as a TriMedia processor of the 8950) that utilise(s) one or more codec(s) suitable for decoding one or more elementary (pre-processed) streams. FIG. 1 contains a schematic illustration of a codec 30 such as an MPEG-2 codec, for decoding one or more relevant pre-processed streams, being utilised by a first processor 25. Here, the first processor 25 is decoding a pre-processed data stream using instructions defined by the relevant codec 30. The codec 30 may be housed as a “system on a chip” (SOC) or in remote memory (e.g. ROM, flash, SDRAM) connected via a BUS;
(d) the preferred embodiment includes one or more second processors 35 (e.g. a MIPS processor of a multi-core processor such as the 8950) that enables post-processing synchronisation including the steps of:
   (i) accessing (e.g. via embedded or other software) tagged reference points on one or more corresponding post-processed streams such as time base reference positions (labelled 80 in FIG. 1);
   (ii) synchronising one or more said post-processed streams, by synchronising tagged reference points (e.g. one or more time or event based reference points) in a first post-processed stream, such as an audio stream (shown at 90 in FIG. 1), with corresponding tagged reference points in a second or subsequent post-processed stream;
   (iii) enabling user control, adjustment and fine-tuning of synchronisation via a control device such as a remote control device or other wireless communications device (e.g. a game controller (Wii, joystick) or mobile phone);
(e) an alternative embodiment utilises fixed-function hardware in conjunction with or instead of one or more second processors 35 for post-processing synchronisation;
(f) an alternative embodiment may display (e.g. by counter, as shown in FIG. 1 at 220) the extent of shift required to synchronise a first post-processed stream (e.g. an audio stream) to one or more time base reference points in a corresponding second or subsequent post-processed stream (e.g. a graphical stream). The shift may be displayed as positive or negative shifts; and
(g) the preferred embodiment delivers one or more synchronised output(s) 130 to:
   (i) one or more multimedia devices 230; or
   (ii) video output to the multimedia device 230 and audio output to a sound (audio) device 210 housed on separate hardware.

The preferred embodiment incorporates a semiconductor such as the PNX8950 NXP (hereafter the 8950), which includes two first processors (in the form of 32-bit 270 MHz “VLIW” media processors called TriMedia processors) and one second processor (in the form of a MIPS processor). The VLIW executes operations in parallel based on a fixed schedule which is determined when the instruction sets are compiled. Consequently, the first processor does not need scheduling hardware, resulting in greater computational power.

The first processors within the 8950 run the media functions such as the decoding of high definition MPEG2 content (720p or 1080i up to 18 mbps) as well as Standard Definition (480i/576i) MPEG4, H.264, DivX, and other media codecs and their corresponding audio formats. These first processors enable video streams to be merged with the graphics planes or video planes on external devices with connection dynamics of up to 81 Mpixel/second. The present invention utilises the functionality of the first and second processors on a chip to offer considerable advances in multistream synchronization over the prior art. The preferred embodiment overcomes the bottlenecks in processing (and consequent problems and defects) that exist with known systems.

In the preferred embodiment, the first processor(s) has no role in synchronising post-processed streams, such as an audio stream 90 to a graphics stream 80. Rather, a second processor(s) and/or fixed function hardware are dedicated to synchronisation of such streams. In known systems, including multi-core systems, the decoding and synchronisation are performed on the same processor(s), which results in suboptimal control and output.

Adjustment by/for the User

The invention enables multichannel synchronisation of audio, video and other data to occur after processing is complete. No known synchronisation system or method synchronises audio to video or other data streams after processing. Rather, known systems attempt synchronisation prior to or during data processing.

FIG. 1 also illustrates an embodiment of the invention as providing an adjustment means to allow the user (e.g. the television viewer) to perform multichannel synchronisation, such as synchronisation of audio to video streams, via a remote control device 260 or other wireless communications means. The user is able to adjust the audio stream to the requirements of the user's audio environment to a graphics stream by shifting the audio stream back and/or forward over the graphics stream time base. This is achieved by the audio stream 90 fixing onto time base markers located on the graphics stream 80 and locking in at a time (in the order of nanoseconds to seconds) from behind or in front of the graphics stream time base.

This adjustment of the audio stream to the graphics stream time base is enabled post decoding of the graphics and video streams such that the adjustment can be made by utilising:
1. fixed-function hardware; and/or
2. embedded software—for example:
   a) flashed onto the system read only memory; or
   b) system on a chip (SOC) software, where the operating system is held in memory (protected or otherwise) on the processor(s)

The user is enabled to control or fine-tune synchronisation by utilising the embedded software or fixed-function hardware to enable the audio adjustment.

Another preferred embodiment, as shown in FIG. 2, uses the same reference numbers, where applicable, as in FIG. 1. Audio adjustment is enabled using the 8950 multi-core processor architecture that combines:
(a) a first post-processed stream such as an audio stream 90 to be synchronised with
(b) one or more second post-processed streams such as a graphics stream 80.

The combination is enabled via one or more second processors 35 (e.g. a MIPS processor in the 8950) that feed(s) synchronised output 130 to a High-Definition Multimedia Interface (HDMI) 140 for transmission of uncompressed, encrypted digital streams to multimedia device 230. The synchronisation of the audio stream 90 to the graphics stream 80 is enabled to be adjusted either automatically or by the user. This adjustment occurs after decoding via the relevant codec 30 by one or more first processors 25. This adjustment takes place at:
a) the fixed-function hardware 100; and/or
b) one or more second processors 35 utilising embedded software housed, for example, in a Memory ROM 60 or a system on a chip (SOC).

In this embodiment, the latency adjustment of the audio stream 90 is synchronised with the one or more reference points on a graphics stream 80 without utilising the resources of the first processor 25. In other words, the first processor(s) has no role in synchronising post-processed streams such as an audio stream 90 to a graphics stream 80. In known systems, including multi-core systems, the decoding and synchronisation are performed on the same processor. The adjustment of the latency in the audio stream 90 is enabled after, and independently to, the decoding functions of the first processor(s) 25. Consequently, the image and audio quality remains intact in the decoding step and all streams remain dynamically available. Multichannel (multistream) synchronisation is not limited to video and audio streams, but can also be used for synchronising multiple displays with associated data streams.

In the preferred embodiment of the present invention the architecture of the system, method and device incorporates processing architecture that synchronises multiple graphics or data streams (channels) post the decoder step to the accompanying or an independent audio stream. When the user perceives that the audio-visual display is not synchronised 170, the user is enabled to synchronise 190 (including fine-tuning synchronisation of) the data output using, for example a remote control device 200, which interfaces with fixed-function hardware 100 and/or a second processor 35 in a multi-core chip (such as the 8950). The second processor 35 and/or fixed-function hardware 100 perform the synchronisation after the first processor's decoding 30 of the transport stream 10. This enables scalable latency adjustment of the audio stream 90, to fine-tune synchronisation with the video stream 80 without impacting on the resources of the first processor 25. Consequently, the image and audio quality remains intact and all channels remain dynamically available. Multichannel synchronisation is not limited to video and audio output, but can also be used for synchronising multiple displays with associated data channels.

### Post-Processing Synchronisation Via Fixed-Function Hardware

In an alternative preferred embodiment the circuit layout has fixed-function hardware to perform the post-processing synchronisation functions. Post-processing synchronisation is known in video processing where the quality of a video is able to be enhanced after the decoding step. However, it is not known in the area of synching audio to video and other data. The fixed-function hardware is used to perform post-processor decoding so as to allow parallel processing via the processor(s) and fixed-function hardware.

Fixed-function hardware overcomes the problems that are encountered with floating point processors (co-processors) and software adaptations in that fixed-function hardware can perform post-processing synchronisation “on the wire”. This enables considerably faster processing speeds than encountered with co-processors and software solutions used on processing chips.

Another major advantage with fixed-function hardware (accelerators) is that they have comparatively very low power demands compared with processing chips. Consequently with portable technologies, such as video phones, the use of fixed-function hardware to enable Lip Synching is an advantage due to its low power requirements, low heat generation and low production cost compared with software processor equivalents.

Multichannel synchronisation also does not require sampling, or slowing or stopping the decoding step, to synchronise different channel outputs, and consequently no signal loss or decrease in the signal to noise ratio occurs. As stated in Electronic Engineering Times⁴ “Dedicated hardware, if done right, should always be more efficient than any programmable approach,” as stated by the chief processor architect for the Philips TriMedia organization. The combination of post-processor synchronisation together with parallelism and fixed-function hardware allows an architecture not to be limited by digital signal processing (DSP) capacities of the processor or other restraints. ⁴ Wilson, R (2005) DSPs draw in power savers Electronic Engineering Times 21 Nov. 2005

The cited limitation with fixed-function hardware is that it is inflexible. This is true with regard to its used in performing decoding functions as the codecs change regularly; however, its use for multichannel synchronisation is a purpose-built function which does not change over time. Therefore, using fixed-function hardware for post processor multichannel synchronisation is advantageous.

The audio stream 90 in the preferred embodiment is delivered to a second processor via the fixed-function hardware for synching, depending on the user's requirements, without re-processing the audio stream 90 at the first processor(s) 25. Therefore, processor resources are not used for decoding and performing synchronisation instructions. The multichannel synchronisation can be adjusted to the user's requirements as needed, by utilising fixed-function hardware and/or embedded software on a second processor.

Control of Synchronisation

Lip Synchronisation is subjective, program/channel/source dependent, and location dependent. Therefore, there is a need for dynamic control that is as simple to perform as turning up or down the volume. This need is more pressing with the increasing uptake of convergent television⁵ and the use of multimedia devices for business to business applications (teleconferencing, videoconferencing), delivery of remote health services (e.g. remote surgery or remote consultations) and the like. ⁵ See Tucker, T and Baker, D (2002) Monitoring and control of audio-to-video delay in broadcast systems. The Society of Motion Picture and Television Engineers (SMP IL) Journal Vol. 111, No 10 Oct. 2002, p465-71.

The adjustment of synchronisation via a remote device, such as a remote control, Wii handset, keyboard or joystick or mobile phone, allows configuration of channels from various sources such as a computer, stereo, video phone, and so on. An example of ease of multichannel synchronization is exemplified by using movement of the remote device (such as a Wii handset, which contains an acceleration sensor) to slow down or, conversely, speed up the audio stream to synchronise with a video stream. This allows dynamic control as the sources of data input change with input selection on, say, convergent television.

Audio “Slicing and Dicing”

Convergent TV enables the “slicing and dicing” a video stream whilst maintaining the integrity of a corresponding audio stream. Consequently, the present invention enables “on the fly” real time synchronisation, with the movement of the remote to synchronise the sound with the video stream. For example, the ability to edit and discard/append the reams of home video with the audio, such as a birthday tune is a simplistic example of the ease of implementing using this preferred embodiment over the current art. To visualise and hear content simultaneously is achieved.

The communication capabilities are envisaged to be used in any application combining multiple channels of communication which are picked up by the sensors and may be edited or require resynchronization. Take the example of email as it is currently used. Often email contains a thread of inputs which are of the form of “different time, same place”. One embodiment enables the user to allow a spoken thread of inputs which when receive can be sped up or slowed down with the waving of a remote control in one direction or another, whilst watching the speaker, the topic of interest or some other data stream. A further embodiment of the invention allows the Lip Syncing device to be included as an add-on device after the signal processing step and pre output to the multimedia device and/or output to a sound device.

Other examples of applications for the invention, apart from digital television, include:
(a) gaming, where multiple players are interactive via multiple data streams;
(b) remote healthcare, including surgery, where synchronised instructions and visualisation of an operation are critical; and
(c) any other input stream which needs to be synchronised to a time base or other reference point, whether fixed or variable—examples include synching to an event occurrence as when synchronising multiple streams of security footage from multiple sources where the event may be a criminal act that serves as the reference point;
(d) real-time synchronisation of transactions, for example, via banking terminals or point of sale terminals;
(e) education, such as distance education and teaching that benefit from dynamic interaction such as tutorials for correspondence students or teaching the playing of a musical instrument remotely or conducting remote experiments.

Although the invention has been described with reference to specific examples, it will be appreciated by those skilled in the art that the invention may be embodied in many different other forms.

1. A synchronisation device for synchronisation of data streams, wherein said synchronisation device includes a dedicated synchronisation means and wherein said dedicated synchronisation means:
(a) includes one or more of the following:
i. one or more processors; and
ii. fixed-function hardware; and
(b) is dedicated to synchronisation of post-processed data streams, such that said synchronisation device is enabled to output synchronised data to one or more of the following:
i. one or more Media Presentation Devices; and
ii. one or more sound devices.

2. A synchronisation device according to claim 1, including an adjustment means, wherein said adjustment means includes:
(a) means for automated adjustment of said synchronisation of post-processed data streams;
(b) means for user-controlled adjustment of said synchronisation of post-processed data streams; and
(c) a combination of (a) and (b) above, such that said synchronisation of post-processed data streams is enabled to be adjusted.

3. A method for synchronisation of data streams, wherein said method includes the step of performing synchronisation of post-processed data streams, wherein said synchronisation is performed by a dedicated synchronisation means and wherein said synchronisation means includes one or more of the following:
(a) one or more processors; and
(b) fixed-function hardware, such that said synchronisation means is enabled to output synchronised data to one or more of the following:
i. one or more Media Presentation Devices; and
ii. one or more sound devices.

4. A method for synchronisation of data streams according to claim 3 including the substeps of:
(a) accessing tagged reference points on a plurality of corresponding postprocessed data streams; and
(b) synchronising said tagged reference points on said corresponding postprocessed data streams.

5. A method for synchronisation of data streams according to claim 3 including an adjustment step, wherein said adjustment step is performed by an adjustment means and wherein said adjustment means includes:
(a) means for automated adjustment of said synchronisation of post-processed data streams;
(b) means for user-controlled adjustment of said synchronisation of post-processed data streams; and
(c) a combination of (a) and (b) above.
